(19) United States
(12) Patent Application Publication
(10) Pub. No.: US 2026/0070401 A1
(43) Pub. Date: Mar. 12, 2026

(54) DRIVING DEVICE FOR ELECTRIC VEHICLES

(71) Applicants: HYUNDAI MOTOR COMPANY, Seoul (KR); KIA CORPORATION, Seoul (KR)

(72) Inventors: Seong Yeop Lim, Hwaseong-si (KR); Seong Wook Hwang, Hwaseong-si (KR); Kijong Park, Hwaseong-si (KR); Yeohyeon Gwon, Hwaseong-si (KR); Jongsung Kim, Hwaseong-si (KR); Yong Jae Lee, Hwaseong-si (KR); Dongwoo Kim, Hwaseong-si (KR); Byungkwan Son, Hwaseong-si (KR); Sihun Noh, Hwaseong-si (KR); Jong Chan Ahn, Hwaseong-si (KR); Hotae Chun, Hwaseong-si (KR)

(73) Assignees: HYUNDAI MOTOR COMPANY, Seoul (KR); KIA CORPORATION, Seoul (KR)

(21) Appl. No.: 19/325,183

(22) Filed: Sep. 10, 2025

(30) Foreign Application Priority Data
Sep. 11, 2024 (KR) 10-2024-0123919

(51) Int. Cl. B60K 1/02; B60K 17/02; B60K 17/16; B60K 17/356; B60K 25/00; F16H 37/08; F16H 63/34

(52) U.S. Cl. CPC B60K 1/02; B60K 17/02; B60K 17/165; B60K 17/356; B60K 25/00; F16H 37/0806; F16H 63/3416; B60K 2025/005

(57) ABSTRACT

A driving apparatus for an electric vehicle operates by combining two motors, three reduction mechanisms, and a power disconnector so that each driving region of the electric vehicle can appropriately perform its role, thereby maintaining efficiency gain and effectiveness in relation to cost, even if required performance specifications increase, or maintaining its driving efficiency at a high level.

### CROSS-REFERENCE TO RELATED APPLICATION

This application claims priority to and the benefit of Korean Patent Application No. 10-2024-0123919 filed with the Korean Intellectual Property Office on Sep. 11, 2024, the entire contents of which are incorporated herein by reference.

### BACKGROUND

### (a) Field of the Disclosure

The present disclosure relates to a driving apparatus for an electric vehicle, and more particularly, the present disclosure relates to a driving apparatus that appropriately performs its role in each driving region of the electric vehicle by combining two motors and three reduction mechanisms.

### (b) Description of the Related Art

In general, a driving apparatus for electric vehicles (commonly called e-Axle, hereinafter referred to as driving apparatus) requires high efficiency, high performance (torque and output improvement), and low-cost design and production within a limited installation space. Depending on whether it is applied as the main drive source in a two-wheel drive (2WD) or four-wheel drive (4WD) electric vehicle, or as an auxiliary drive source in a four-wheel drive (4WD) electric vehicle, the driving apparatus is equipped with a high-cost high-efficiency motor system and a low-cost low-efficiency or non-rare-earth element motor system.

In cases where such a driving apparatus is applied as the main driving source, it is configured as a single driving platform under the condition that it satisfies mounting or installation requirements while focusing on low cost along with high efficiency for improving the travel distance and fuel efficiency of the electric vehicle, and responds to a plurality of required performance specifications by changing only some of the design specifications.

However, when applying a motor system equipped with a conventional rare-earth element permanent magnet as a driving apparatus, there is a limit to achieving both high efficiency and low-cost conditions within a limited installation space with only a simple electrical design change. When torque and output performance exceeding a certain arbitrary limit are required, the efficiency gain and effect that can be obtained relative to the investment cost decrease rapidly.

Meanwhile, in cases where the driving apparatus is applied as an auxiliary driving source, the focus is on low-cost development rather than high efficiency under conditions that satisfy vehicle performance parameters. Therefore, a motor system equipped with an inverter is adopted that replaces the expensive power module in the electric power converter of the driving apparatus applied as the main driving source with a low-cost one, or a motor system equipped with a similar motor or non-rare-earth element motor with lower cost and lower efficiency characteristics is adopted rather than the motor equipped with rare-earth element permanent magnet in the main driving source.

When a motor equipped with a permanent magnet is adopted as the driving source of a four-wheel drive (4WD) electric vehicle, when driving a two-wheel drive (2WD) vehicle with only the main driving source, a significant no-load drag (loss) caused by the motor equipped with a permanent magnet occurs in the wheel where the auxiliary driving source is positioned. This results in a problem of a decrease in the travel distance and fuel efficiency of the four-wheel drive (4WD) electric vehicle.

To solve this problem, a separate disconnect device must be added between the differential gear of the auxiliary drive source and the wheel. This causes another problem of increased investment cost and weight.

To implement an auxiliary driving source with the same torque and output specifications as a motor system equipped with a non-rare-earth element motor, there is a drawback in that the size, volume, or cooling capacity must increase compared to a driving apparatus that adopts a motor equipped with a rare-earth element permanent magnet.

In the case where a driving apparatus implemented with a motor equipped with rare-earth element permanent magnets requires addition or improvement of hill climbing and towing capability in addition to the basic required performance, a change in the overall design of the reduction mechanism, motor, and electric power converter in the conventional driving apparatus is inevitable. This causes a problem in that the efficiency gain and effect are lowered compared to the investment cost.

The information contained in this background section is intended to promote understanding of the background of the disclosure and may include subject matter that is not conventional art already known to a person of ordinary skill in the field to which this technology belongs.

### SUMMARY

The present disclosure provides a driving apparatus for an electric vehicle that can maintain efficiency gain and effectiveness in relation to cost or maintain high driving efficiency even when required performance specifications increase by operating two motors and three reduction mechanisms so that they can appropriately perform their roles in each driving region of the electric vehicle.

A driving apparatus for an electric vehicle according to the present disclosure may include a first motor, which has a first motor shaft arranged parallel to one of at least two drive shafts on both sides of the driving apparatus. The first motor connects a differential and wheels on both sides of the driving apparatus and transmits driving torque to the wheels on both sides. The driving apparatus may also include a second motor, which has a second motor shaft spaced apart from the drive shafts on both sides, arranged parallel to the drive shaft on the other side, and arranged to face the first motor on the same axis as the first motor shaft of the first motor. The driving apparatus also includes a first reduction mechanism having a first planetary gear set configured on or coupled to the first motor shaft and having first, second, and third rotation elements, reducing speed input from the first motor, and outputting the driving torque or a first torque form the first motor. The driving apparatus further includes a second reduction mechanism having a second planetary gear set configured on or coupled to the second motor shaft of the second motor and having fourth, fifth, and sixth rotation elements, reducing speed input from the second motor, and outputting the driving torque or a second torque from the second motor. The driving apparatus also includes a third reduction mechanism having an output gear fixed to the output side of the first reduction mechanism and a differential ring gear of a differential externally engaged with the output gear. The driving apparatus further includes a power disconnector configured between the first motor shaft of the first motor and the output side of the second reduction mechanism and configured to connect or disconnect, selectively, power between the first motor shaft and the second reduction mechanism.

The first and second motors may be configured with the same or different exterior diameter and axial direction dimensions.

In the first reduction mechanism, the first rotation element may be connected to the first motor shaft and operate as an input element. The second rotation element may be connected to the output gear of the third reduction mechanism and operate as an output element. The third rotation element may be fixed to a housing and operate as a fixed element.

The first planetary gear set may be a single pinion planetary gear set, in which the first, second, and third rotation elements are a first sun gear, a first planetary carrier, and a first ring gear, respectively.

In the second reduction mechanism, the fourth rotation element may be connected to the second motor shaft and operate as an input element. The fifth rotation element may be connected to the power disconnector and operate as an output element. The sixth rotation element may be fixed to a housing and operate as a fixed element.

The second planetary gear set may be a single pinion planetary gear set in which the fourth, fifth, and sixth rotation elements are a second sun gear, a second planetary carrier, and a second ring gear, respectively.

The third reduction mechanism may be placed or located between the first reduction mechanism and the second reduction mechanism.

The output gear of the third reduction mechanism may be fixedly connected to the second rotation element of the first reduction mechanism.

The power disconnector may be a dog clutch or a wet-type clutch, i.e., a wet clutch.

The power disconnector may be operated to disconnect the power of the second motor during constant two-wheel drive (2WD) operation and four-wheel drive (4WD) low-load operation, and may be operated to connect the power of the first and second motors during 4WD medium-load or higher operation and constant 4WD operation.

The driving apparatus according to the present disclosure may further include a parking gear configured on or coupled to the power disconnector connected to the first motor shaft to perform a parking function by a parking unit.

The driving apparatus according to the present disclosure may further include an air conditioning compressor that can be connected to the second motor via a power connector.

The power connector may include a normally open type electronic clutch configured to enable power connection between the second motor shaft of the second motor and a rotation shaft of the compressor. The power connector may include an electronic belt pulley apparatus that connects a driving pulley configured on or coupled to the second motor shaft of the second motor and a driven pulley configured on or coupled to the rotation shaft of the compressor with a belt.

The driving apparatus for an electric vehicle according to the present disclosure may operate by combining the first and second motors, the first, second and third reduction mechanisms, and the power disconnector so that these components can appropriately perform their roles in each driving region of the electric vehicle. The driving torque is thereby increased and the acceleration performance during starting and low-speed driving is thereby improved. Thus, the fuel efficiency of the electric vehicle is improved by driving in the efficient driving region or section of the motor.

In a travel distance or fuel economy driving region, only one motor is operated to enable high efficiency driving. In a high load driving region, two motors are operated simultaneously so that the insufficient torque and output to the wheel by the first motor can be supplemented by the torque and output by the second motor.

In addition, according to the present disclosure of the driving apparatus for an electric vehicle, a double safety measure can be established through a parking gear. Even though a mechanical parking device is applied by configuring a parking gear on one output side of a power disconnector between reduction mechanisms, there is no change in the axis direction dimension of the entire driving apparatus. Thus, the design degree of freedom for the two motors can be increased.

In addition, the driving apparatus for an electric vehicle according to the present disclosure configures an air conditioning compressor that is driven by the torque of the second motor. Thus, it can be driven with high efficiency according to driving conditions such as stopping, driving, charging, or parking of the vehicle, thereby providing optimal air conditioning performance.

In addition, the effects that can be obtained or expected due to the various embodiments and features of the present disclosure are directly or implicitly disclosed in the detailed description. In other words, various effects anticipated according to the present disclosure are disclosed in the detailed description that follows.

### BRIEF DESCRIPTION OF THE DRAWINGS

These drawings are intended for reference in explaining various disclosure and therefore should not be interpreted as limiting the technical ideas of the present disclosure to the accompanying drawings.

FIG. 1 is a schematic diagram of a driving apparatus for an electric vehicle according to various disclosure of the present disclosure.

FIG. 2 is a schematic diagram of a driving apparatus for an electric vehicle according to various disclosure of the present disclosure.

FIG. 3 is a schematic diagram of a driving apparatus for an electric vehicle according to various disclosure of the present disclosure.

The drawings referenced above are not necessarily drawn to scale and should be understood as presenting rather simplified representations of various features illustrating the basic principles of the present disclosure. For example, certain design features of the present disclosure, including particular dimensions, direction, position, and shape, will be determined in part by the particular intended application and usage environment.

### DETAILED DESCRIPTION OF EMBODIMENTS

Hereinafter, referring to the drawings, embodiments disclosed in this specification are described in detail. Identical or similar components are given the same or similar reference numerals and redundant descriptions thereof have been omitted.

When describing embodiments disclosed in this specification, if it was determined that a detailed description of related known technology may have obscured the gist of the embodiments disclosed in this specification, the detailed description has been omitted. In addition, the attached drawings are only intended to facilitate understanding of the embodiments disclosed in this specification. The technical ideas disclosed in this specification are not limited by the attached drawings and should be understood to include all modifications, equivalents, or substitutes included in the spirit and technical scope of the present disclosure.

Terms that include ordinal numbers, such as first, second, etc., may be used to describe various configurations of elements, but the components are not limited by the terms. The terms are used solely to distinguish one component from another.

When a component is said to be “connected” or “combined” to another component, it should be understood that the component may be directly connected or connected to that other component, but there may also be other components in between. On the other hand, when a component is said to be “directly connected” or “directly combined” to another component, it should be understood that there are no other components in between.

In this application, it should be understood that terms such as “include” or “have” and variations thereof are intended to specify the presence of a feature, number, step, operation, component, part, or combination thereof described in the specification. Such terms do not exclude in advance the possibility of the presence or addition of one or more other features, numbers, steps, operations, components, parts, or combinations thereof.

Terms such as “unit”, “portion”, “part”, “module”, and “means” described in the specification are assigned or used interchangeably only for the convenience of writing the specification, and do not have distinct meanings or roles in themselves. Terms such as “unit”, “portion”, “part”, “module”, and “means” described in the specification may mean a unit that processes at least one function or operation, and this may be implemented by hardware, software, or a combination of hardware and software. When a component, device, unit, portion, part, module, means, member, element, apparatus, or the like of the present disclosure is described as having a purpose or performing an operation, function, or the like, the component, device, unit, portion, part, module, means, member, element, apparatus, or the like should be considered herein as being “configured to” meet that purpose or to perform that operation or function. The above listed or other such components may separately embody or be included with a processor and a memory, such as a non-transitory computer readable media, as a part thereof.

As used herein, the singular forms are intended to include the plural forms as well, unless the context clearly indicates otherwise. As used herein, the term “and/or”includes any one or all combinations of the associated listed items.

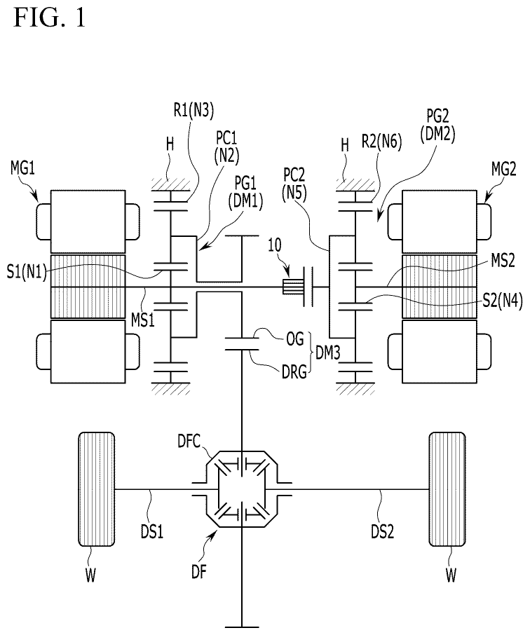

FIG. 1 is a schematic diagram of a driving apparatus for an electric vehicle according to the present disclosure.

Referring to FIG. 1, a driving apparatus for an electric vehicle (hereinafter, referred to as driving apparatus) according to the present disclosure includes a first motor MG1, a second motor MG2, first, second, and third reduction mechanisms DM1, DM2, and DM3, and a power disconnector 10.

In other words, the driving apparatus according to a first embodiment of the present disclosure may use two motors, including the first motor MG1 and the second motor MG2, as a driving source.

The first and second motors MG1 and MG2 can perform motor and generator functions as disclosed herein, and each includes a stator fixed to a housing and a rotor rotatably supported inwardly of the stator in a radial direction. In the first embodiment of the present disclosure, the first and second motors perform the function of a driving motor as their main function.

The driving apparatus according to the first embodiment of the present disclosure includes a differential DF and wheels of a vehicle. The differential DF and both wheels W are connected to enable power delivery through drive shafts DS1 and DS2, respectively. The drive shafts DS1 and DS2 and wheels W are respectively arranged on opposite sides of the differential DF and the vehicle.

The differential DF includes a differential ring gear DRG connected to a differential case DFC.

The first motor MG1 is arranged parallel, according to the motor output, to one of the drive shafts DS1 and DS2, which transmit driving torque to both wheels W.

The first motor MG1 outputs driving torque through a first motor shaft MS1.

The second motor MG2 outputs driving torque through a second motor shaft MS2.

The second motor MG2 is arranged parallel, according to the motor output, to the drive shaft DS2 of the other side among the drive shafts DS1 and DS2 that transmit driving torque to the wheels W on both sides. The second motor shaft MS2 is arranged to face the first motor MG1 on the same axis as the first motor shaft MS1 of the first motor MG1.

The first reduction mechanism DM1 may be formed of a first planetary gear set PG1 having first, second, and third rotation elements N1, N2, and N3 and configured on the first motor shaft MS1. The first reduction mechanism DM1 is configured to reduce speed input from the first motor MG1 and output it to the differential ring gear DRG of the differential DF.

The first reduction mechanism DM1 has a first rotation element N1 connected to the first motor shaft MS1 and operating as an input element, a second rotation element N2 operating as an output element, and a third rotation element N3 fixed to a housing H and operating as a fixed element.

The first planetary gear set PG1, which is the first reduction mechanism DM1, may be a single pinion planetary gear set including: a first sun gear S1, which is the first rotation element N1; a first planetary carrier PC1, which supports rotation and revolution of a plurality of first pinion gears P1 that are externally engaged radially equally spaced on the exterior circumference side of the first sun gear S1; and the third rotation element N3, which is a first ring gear R1, and which is internally engaged with a plurality of first pinion gears P1 and is power connected to the first sun gear S1.

The second reduction mechanism DM2 may be a second planetary gear set PG2 having fourth, fifth, and sixth rotation elements N4, N5, and N6 and configured on the second motor shaft MS2. The second reduction mechanism DM2 is configured to reduce speed input from the second motor MG2.

The second reduction mechanism DM2 has the fourth rotation element N4 connected to the second motor shaft MS2 and operating as an input element, the fifth rotation element N5 operating as an output element, and the sixth rotation element N6 fixed to housing H and operating as a fixed element.

The second planetary gear set PG2, which is the second reduction mechanism DM2, may be a single pinion planetary gear set including: a second sun gear S2, which is the fourth rotation element N4; a second planetary carrier PC2, which supports rotation and revolution of a plurality of second pinion gears P2 that are externally engaged radially equally spaced on the exterior circumference side of the second sun gear S2; and a second ring gear R2, which is the sixth rotation element N6 that is internally engaged with a plurality of second pinion gears P2 and is power connected to the second sun gear S2.

The third reduction mechanism DM3 includes an output gear OG fixed to the output side of the first reduction mechanism DM1 and a differential ring gear DRG of the differential DF externally engaged with the output gear OG.

The third reduction mechanism DM3 is placed or located between the first reduction mechanism DM1 and the second reduction mechanism DM2. The output gear OG is fixedly connected to the second rotation element N2, which is the output element of the first reduction mechanism DM1.

The driving apparatus according to the first embodiment of the present disclosure comprises an integrated driving system in which the first and second motors MG1 and MG2, the first, second, and third reduction mechanisms DM1, DM2, and DM3, and a separate electric power converter (not shown) are mounted in one housing H.

The first and second motors MG1 and MG2 may be applied with different types of motors, such as a motor with a high-temperature permanent magnet or a motor with a non-high-temperature permanent magnet, or with similar types of motors with different specifications and a relative difference in the maximum rotation speed of at least 5,000 RPM.

The first and second motors MG1 and MG2 may be configured with the same or different exterior diameters and axial direction dimensions, but the stacking length of the second motor MG2 is designed in one example not to exceed the stacking length of the first motor MG1. Even if the stacking length exceeds that, it may be designed so as to satisfy the installation or mounting requirements of the driving apparatus or not to affect the axial direction length (overall length) of the driving apparatus.

The power disconnector 10 is configured between the first motor shaft MS1 of the first motor MG1 and the fifth rotation element N5 on the output side of the second reduction mechanism DM2 to connect or disconnect power between them.

The power disconnector 10 may be a dog clutch or a wet type clutch. When the power disconnector 10 operates, the first motor shaft MS1 and second motor shaft MS2 are connected. When power disconnector 10 is de-operated, the first motor shaft MS1 and second motor shaft MS2 are disconnected.

The power disconnector 10 is applied as the main driving source of the 4WD of the driving apparatus according to the first embodiment of the present disclosure. The power disconnector 10 may be controlled to operate to disconnect the power connection of the second motor MG2 during constant 2WD operation and 4WD low-load operation, and to connect the power of the first and second motors MG1 and MG2 to each other during 4WD medium-load or high-load operation and constant 4WD operation. As used herein, low, medium, and high loads are relative values. These values consider various factors such as vehicle specifications, required performance, sales region within preset driving ranges, road conditions, elevation changes, and the like. Low-load operation is lower than medium-load operation and is for vehicle operation under low load, i.e., lower stress or lower power requirement conditions where only the one motor is required. High-load operation is higher than medium-load operation and is for vehicle operation under high load, i.e., high stress or high power requirement conditions where both motors are required. Medium-load operation is between low-and high-load operation and is for vehicle operation where both motors may be required or helpful. According to the present disclosure, when the first motor MG1 drives, the torque is input to the first sun gear S1, which is the first rotation element N1 of the first reduction mechanism DM1, through the first motor shaft MS1, the first ring gear R1, which is the third rotation element N3, acts as a fixed element, and the first planetary carrier PC1, which is the second rotation element N2, decelerates, and outputs the torque to the output gear OG of the third reduction mechanism DM3.

The torque of the first motor MG1, the speed of which is reduced by the first reduction mechanism DM1, is transmitted to the differential ring gear DRG of the differential DF through the output gear OG of the third reduction mechanism DM3.

The differential DF absorbs the difference in rotation speed between the wheels W on both sides and transmits driving torque to the wheels W on both sides through the drive shafts DS1 and DS2 on both sides.

When the second motor MG2 is driven and the power disconnector 10 is operated, the torque is input to the second sun gear S2, which is the fourth rotation element N4 of the second reduction mechanism DM2, through the second motor shaft MS2, the second ring gear R2, which is the sixth rotation element N6, acts as a fixed element, and the second planetary carrier PC2, which is the fifth rotation element N5, reduces the speed, and outputs the torque.

The torque output from the second planetary carrier PC2 is transmitted to the first motor shaft MS1 of the first motor MG1 to assist the torque and output of the first motor MG1.

In other words, this driving apparatus enables high efficiency driving by operating only the first motor MG1 in a travel distance or fuel economy driving region. In a high load driving region, the driving apparatus operates the first and second motors MG1 and MG2 simultaneously so that the insufficient torque and output to the wheel by the first motor MG1 can be supplemented by the torque and output by the second motor MG2.

According to the first embodiment of the present disclosure, the driving apparatus may be configured such that the first and second motors MG1 and MG2 use different types of motors, or may be of the same type with a relative difference of at least 5,000 RPM in their maximum rotation speeds. One may be configured having a high efficiency motor system (i.e., including a power module, an electric power converter, and an inverter) equipped with a rare-earth element permanent magnet. The other may configured having a low efficiency (relative comparison reference) or non-rare-earth element motor system (including a power module, and an inverter) without a permanent magnet. Alternatively, both may be configured having a low efficiency motor system (including a power module and an inverter).

In other words, in responding to a plurality of required performances of the driving apparatus within a limited mounting space with a single platform, the first motor MG1 equipped with a rare-earth element permanent magnet constituting a high-efficiency motor system can be applied equally to the driving platform for each output with one minimum fixed specification. The heterogeneous second motor MG2 constituting a low-efficiency motor system can provide a driving platform for each output that matches a plurality of required performances with a plurality of design specifications by prioritizing the lowest price or the highest cost-effectiveness.

Meanwhile, the driving apparatus according to the first embodiment of the present disclosure the specifications of the motor system of the first and second motors MG1 and MG2 may be efficiently configured depending on whether it is the main driving source or the auxiliary driving source of 4WD.

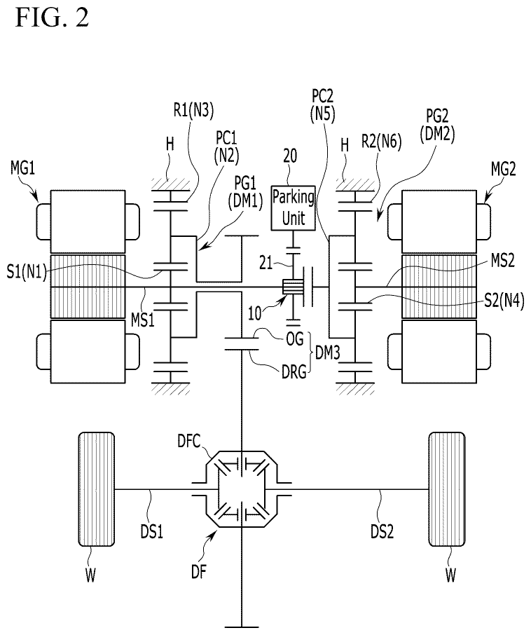

FIG. 2 is a schematic diagram of a driving apparatus for an electric vehicle according to the present disclosure.

Referring to FIG. 2, the driving apparatus described in FIG. 2 differs from the driving apparatus described in FIG. 1 in that a parking gear 21 is configured on the power disconnector 10.

In other words, the parking gear 21 may be configured with the power disconnector 10 connected to the first motor shaft MS1 so that the driving apparatus performs the parking function by the parking unit 20.

The parking gear 21 is intended to provide a parking function to the reduction mechanism as part of a double safety measure.

When applying a general sprag-type mechanical parking device, the entire driving apparatus for the electric vehicle becomes larger in the axial direction, which makes installing or mounting the system on the vehicle more difficult. Also, when the motor size is larger to increase the driving torque of the driving apparatus, the design degree of freedom for the axial direction may be significantly reduced.

According to the driving apparatus for an electric vehicle according to the present disclosure, even if a mechanical parking device is applied, the design degree of freedom of the first and second motors MG1 and MG2 may be increased without changing the axial direction dimensions of the entire driving apparatus for an electric vehicle. In other words, a parking gear 21 may be configured on one output side of the power disconnector 10 that is coaxially engaged with the first motor shaft MS1 of the first motor MG1.

The driving apparatus of FIG. 2 differs only in the configuration of adding the parking gear 21 compared to the driving apparatus described in FIG. 1. All other components and the connection relationships and operations of each component of the driving apparatus of FIG. 1 are the same as those of the driving apparatus of FIG. 1, so the description has not been repeated herein.

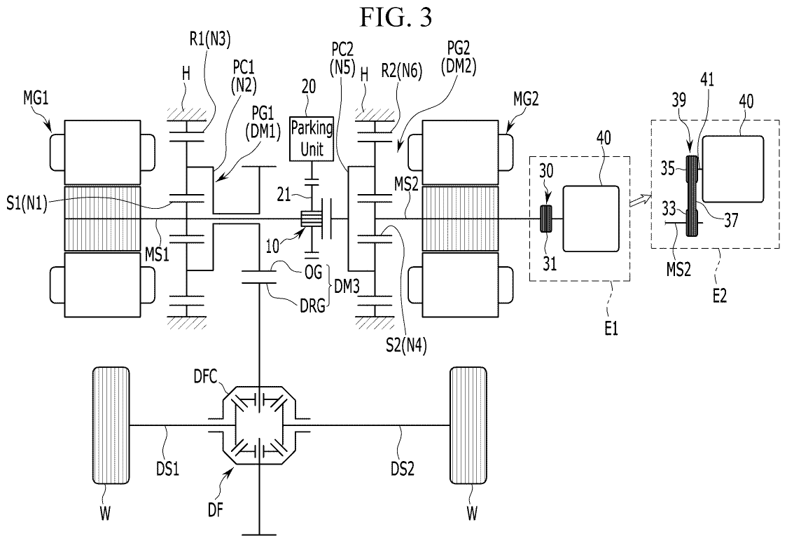

FIG. 3 is a schematic diagram of a driving apparatus for an electric vehicle according to the present disclosure.

Referring to FIG. 3, the driving apparatus described in FIG. 3 differs from the driving apparatus in FIG. 2 in that an air conditioning compressor 40 is added that can be connected to the second motor MG2 via a power connector 30.

The power connector 30 may include a normally open type electronic clutch 31 as an Example E1. The clutch 31 may be configured to enable power connection between the second motor shaft MS2 of the second motor MG2 and a rotation shaft 41 of the compressor 40.

As another example E2, the power connector 30 may include an electronic belt pulley apparatus 39 that power connects a driving pulley 33 configured on the second motor shaft MS2 of the second motor MG2 and a driven pulley 35 configured on the rotation shaft 41 of the compressor 40 with a belt 37.

When the power connector 30 is applied to the electronic clutch 31 or electronic belt pulley apparatus 39, it can operate according to an electrical signal supplied from a control apparatus to connect or block the torque of the second motor MG2 to the compressor 40. Thus, the driving apparatus described in FIG. 3 differs from other embodiments in that the air conditioning compressor 40 is added. All other components and the relationship between each component of the driving apparatus in FIG. 3 are the same as those of the other embodiments, so a description has not been repeated herein.

The air conditioning compressor 40 can provide optimal air conditioning performance by utilizing the torque of the second motor MG2 when the vehicle is stopped, driving, charging, or at the park or P signal position of the shift lever.

The compressor 40 is configured to operate in the region where the rotation speed and output torque of the second motor MG2 are optimal when the power disconnector 10 is turned off, but does not rotate to a high rotation speed corresponding to the maximum vehicle speed. Thus, it can be configured as a relatively low-cost type without high performance, and a variable capacity type or electron clutch type compressor can be applied that can be adjusted by the existing driver.

In the driving apparatus for an electric vehicle applied as a main or auxiliary driving source, when the vehicle is stopped, charged, driven at low speed, or driven at high speed exceeding the maximum rotation speed of the second motor MG2, if there is a demand for driving the compressor 40, the power disconnector 10 is kept in the released state, and the compressor 10 is driven by the torque of the second motor MG2 to provide optimal air conditioning performance.

Meanwhile, during normal driving excluding the driving conditions above, if the required driving torque of the vehicle requires the driving torque of the second motor MG2, and the sum of the converted output torque of the second motor MG2 required as the required driving torque of the vehicle and the driver torque of the compressor 40 is less than the maximum output torque of the second motor MG2 while the power disconnector 10 is operating, the driving performance of the vehicle may be secured by the sum of the required driving torque of the second motor MG2. A at the same time, the compressor 40 may be normally operated by the residual driving torque of the second motor MG2 at the rotation speed corresponding to the vehicle speed.

If the sum of the converted output torque of the second motor MG2 required as the required driving torque of the vehicle and the driver torque of the compressor 40 exceeds the maximum output torque of the second motor MG2, or if the required driving torque of the vehicle requires almost all of the converted output torque of the second motor MG2, the compressor 40 may be operated at the lowest performance level to secure the driving performance of the vehicle as a top priority. Alternatively, the operation of the compressor 40 may be stopped by electronically controlling the power connector 30.

Therefore, the driving apparatus for an electric vehicle according to the embodiments of the present disclosure as described above operates by combining the first and second motors MG1 and MG2, the first, second, and third reduction mechanisms DM1, DM2, and DM3, and the power disconnector 10. Thus, these components can appropriately perform their roles in each driving region of the electric vehicle. This increases the driving torque, improves the acceleration performance during starting and low-speed driving, and improves the fuel efficiency of the electric vehicle by driving in the efficient driving region or section of the motor.

In other words, in a travel distance or fuel economy driving region, only the first motor MG1 is operated to enable high efficiency driving. In a high load driving region, the first and second motors MG1 and MG2 are operated simultaneously so that the insufficient torque and output to the wheel by the first motor MG1 can be supplemented by the torque and output by the second motor MG2.

In addition, according to the driving apparatus for an electric vehicle of the present disclosure, it is possible to establish a double safety measure through the parking gear 21. A parking function can be provided by configuring the parking gear 21 on one output side of the power disconnector 10 between the reduction mechanisms. Through this, the change in the axis direction or dimension of the entire driving apparatus can be minimized even when applying a mechanical parking device, thereby increasing the design degree of freedom of the first and second motors MG1 and MG2.

In addition, according to the driving apparatus of the present disclosure, the air conditioning compressor 40 driven by the torque of the second motor MG2 can be configured. This allows the compressor 40 to be driven with high efficiency and to provide optimal air conditioning performance depending on driving conditions such as vehicle stopping, driving, charging, or parking.

Although the present disclosure has been described above with reference to certain embodiments thereof, it should be understood by those of ordinary skill in the art that various modifications and changes may be made to the present disclosure without departing from the spirit and scope of the present disclosure as set forth in the claims below.

### DESCRIPTION OF SYMBOLS

MG1; first motor
MS1: first motor shaft
MG2; second motor
MS2: second motor shaft
DM1, DM2, DM3: first, second, third reduction mechanism
PG1, PG2; first, second planetary gear set
DF; differential
DFC: differential case
DRG: differential ring gear
DS1, DS2: drive shaft
W: wheel
H; housing
N1, N2, N3, N4N, N5, N6: first, second, third, fourth, fifth, sixth rotation element
S1, S2: first, second sun gear
PC1, PC2: first, second planetary carrier
R1, R2: first, second ring gear
P1, P2: first, second planetary gear
10: power disconnector
20: parking unit
21: parking gear
30: power connector
31: electronic clutch
33: driving pulley
35: driven pulley
37: belt
39: electronic belt pulley apparatus
40: compressor

What is claimed is:

1. A driving apparatus for an electric vehicle having drive shafts, a differential, and wheels, the driving apparatus comprising:
a first wheel on one side and a second wheel on another side of the driving apparatus;
a first drive shaft connected to the first wheel on the one side and a second drive shaft connected to the second wheel on the other side;
a differential connected to the first and second drive shafts;
a first motor having a first motor shaft arranged parallel to the first drive shaft and connected to the differential and the first and second wheels and configured to transmit driving torque to the first and second wheels;
a second motor having a second motor shaft arranged parallel to the second drive shaft and arranged to face the first motor coaxial with the first motor shaft;
a first reduction mechanism including a first planetary gear set coupled to the first motor shaft and having first, second, and third rotation elements, configured to reduce speed input from the first motor and to output a first torque;
a second reduction mechanism including a second planetary gear set coupled to the second motor shaft and having fourth, fifth, and sixth rotation elements, configured to reduce speed input from the second motor and to output a second torque;
a third reduction mechanism including an output gear fixed to an output side of the first reduction mechanism and a differential ring gear of the differential externally engaged with the output gear; and
a power disconnector between the first motor shaft of the first motor and the output side of the second reduction mechanism configured to selectively connect and disconnect power between the first motor shaft and the second reduction mechanism.

2. The driving apparatus of claim 1, wherein the first and second motors are configured with the same or different exterior diameter and axial direction dimensions.

3. The driving apparatus of claim 1, wherein, in the first reduction mechanism, the first rotation element is connected to the first motor shaft and operates as an input element, the second rotation element is connected to the output gear of the third reduction mechanism and operates as an output element, and the third rotation element is fixed to a housing and operates as a fixed element.

4. The driving apparatus of claim 1, wherein the first planetary gear set is a single pinion planetary gear set in which the first, second, and third rotation elements are a first sun gear, a first planetary carrier, and a first ring gear, respectively.

5. The driving apparatus of claim 1, wherein, in the second reduction mechanism, the fourth rotation element is connected to the second motor shaft and operates as an input element, the fifth rotation element is connected to the power disconnector and operates as an output element, and the sixth rotation element is fixed to a housing and operates as a fixed element.

6. The driving apparatus of claim 1, wherein the second planetary gear set is a single pinion planetary gear set in which the fourth, fifth, and sixth rotation elements are a second sun gear, a second planetary carrier, and a second ring gear, respectively.

7. The driving apparatus of claim 1, wherein the third reduction mechanism is located between the first reduction mechanism and the second reduction mechanism.

8. The driving apparatus of claim 1, wherein the output gear of the third reduction mechanism is fixedly connected to the second rotation element of the first reduction mechanism.

9. The driving apparatus of claim 1, wherein the power disconnector is a dog clutch or a wet clutch.

10. The driving apparatus of claim 1, wherein the power disconnector is operable to disconnect the power of the second motor during constant two-wheel drive (2WD) operation and four-wheel drive (4WD) low-load operation, and is operable to connect the power of the first and second motors during 4WD medium-load or higher operation and constant 4WD operation.

11. The driving apparatus of claim 1, further comprising:
a parking gear coupled to the power disconnector connected to the first motor shaft to perform a parking function by a parking unit.

12. The driving apparatus of claim 1, further comprising:
an air conditioning compressor connected to the second motor via a power connector.

13. The driving apparatus of claim 12, wherein the power connector comprises:
a normally open electronic clutch configured to enable power connection between the second motor shaft and a rotation shaft of the compressor.

14. The driving apparatus of claim 12, wherein the power connector comprises:
an electronic belt pulley apparatus that connects a driving pulley coupled to the second motor shaft and a driven pulley coupled to the rotation shaft of the compressor with a belt.
